(19) United States
(12) Patent Application Publication
(10) Pub. No.: US 2025/0253112 A1
(43) Pub. Date: Aug. 7, 2025

(54) ELECTROMECHANICAL SWITCH AND METHOD FOR MANUFACTURING THE SAME

(71) Applicant: Korea Advanced Institute of Science And Technology, Daejeon (KR)

(72) Inventors: Jun-Bo YOON, Daejeon (KR); Soyoung LEE, Daejeon (KR); Taesoo KIM, Daejeon (KR)

(73) Assignee: Korea Advanced Institute of Science And Technology, Daejeon, (KR)

(21) Appl. No.: 19/046,042

(22) Filed: Feb. 5, 2025

(30) Foreign Application Priority Data
Feb. 6, 2024 (KR) 10-2024-0018331

(51) Int. Cl. H01H 59/00; H01H 1/00

(52) U.S. Cl. CPC H01H 59/0009; H01H 1/0036; H01H 1/0094

(57) ABSTRACT

The present invention relates to an eletromechanical switch and a method for manufacturing the same, and more particularly, to an electromechanical switch with an electrostatic driving method having a fast-switching time, low on-resistance, and low leakage current and a method for manufacturing the same. An electromechanical switch according to an embodiment of the present invention includes: a substrate; a first electrode disposed on the substrate; a second electrode spaced apart from the first electrode on the substrate; a third electrode disposed on the first electrode and the second electrode, including a contact part spaced apart from the first electrode to form an air gap, and bringing the contact part into mechanical contact with the first electrode by electrostatic force with the second electrode.

### CROSS-REFERENCE TO RELATED APPLICATIONS

This US non-provisional patent application claims priority under 35 USC § 119 of Korean Patent Application No. 10-2024-0018331, filed on Feb. 6, 2024, the entire contents of which are hereby incorporated by reference.

### BACKGROUND

The present invention relates to an eletromechanical switch and a method for manufacturing the same, and more particularly, to an electromechanical switch with an electrostatic driving method having a fast-switching time, low on-resistance, and low leakage current and a method for manufacturing the same.

In recent years, a design of power dissipation in a semiconductor system is a critical issue to efficiently process a massive amount of data generated as technologies related to the fourth industrial revolution, such as artificial intelligence, big data, deep learning, and 5G, are explosively developed.

Power consumed in the semiconductor system may be largely classified into dynamic power and leakage power. The dynamic power refers to power consumed when a circuit is operating, while the leakage power refers to power consumed even when the circuit is not operating without being related to an operation of the circuit.

As illustrated in FIG. 1, a technology that fundamentally blocks leakage power while an amount of leakage power per unit area surpasses an amount of dynamic power per unit area as a micro-process less than 20 nm gate length is a key for realizing an ultra-low-power artificial intelligence semiconductor system.

As illustrated in FIG. 2, power gating is one of promising technologies that blocks an idle logic block in a standby mode from power by using an additional switch to reduce the leakage power loss in the logic block.

To realize the idle power gating, a power gating switch (PGS) needs to satisfy following conditions i and ii.
i. Low On-Resistance (<1Ω): When power is applied to the circuit through the PGS, the low on-resistance may reduce voltage drop (IR drop) to minimize a delay generated in the logic block.
ii. Extremely low leakage current (<1Ω): When power is applied to the circuit through the PGS, the extremely low leakage current of the PGS may minimize leakage power generated in the circuit.

To satisfy the conditions i and ii, various next-generation new elements such as tunnel FET (T-FET), ferroelectric FET (FE), feedback FET (FB), and impact ionization MOS (I-MOS) are being researched. However, as illustrated in FIG. 3, since each of the on-resistance and the leakage current that are key factors of the power gating switch is still large, the elements may not be substantially used as the power gating elements.

A micro/nano electromechanical switch (M/NEM switch) is an element that switches current and voltage abruptly through mechanical contact between at least two metals with an air gap therebetween. A micro-sized MEM switch driven by electrostatic force was first proposed by Peterson in 1978.

The M/NEM switch has an advantage of having relatively low on-resistance and a relatively high on/off current ratio in the on state through the mechanical contact between the two metals, while having leakage current and standby power, each of which is close to 0, because two electrodes are spaced apart from each other in the off state.

As the NEM switch at a nanoscale may be realized together with development of a semiconductor process technology, various new elements serving complementary functions in a CMOS-based semiconductor system, such as a NEM logic operating at ultra-high temperature and an ultra-low-power non-volatile NEM memory, are being reported.

Since extremely low leakage current and low on-resistance characteristics of the NEM switch are essential for power gating technology, research for applying the NEM switch to the power gating technology are being tried by worldwide research centers. According to recent research results, simulations show that maximum 30% energy saving is obtained by applying the NEM power gating switch (NEM-PGS) to various functional units (such as DSP/GPU, a cache memory, and a baseband processor) in 14 nm FinFET-based mobile SoCs.

The power gating system using the NEM switch may be realized by having not only the extremely low leakage current of the NEM switch but also the low on-resistance and fast switching characteristics in the on state. Although various research reports that the NEM switch has extremely low leakage current due to intrinsic characteristics thereof, the NEM switch that simultaneously exhibits the low on-resistance and the fast-switching time is not reported yet. When the logic block is in the on state, the low on-resistance is essential to prevent a voltage drop (IR drop) of a supply voltage. Also, the fast-switching time is an important factor for NEM-PGS so as to be quickly converted from the idle state to the on state.

However, all the currently performing research are based on simulation modeling results, and no research substantially perform design/manufacturing/CMOS-integration, and verification of the NEM switch for the power gating. Substantially, in a 20 nm technology node, the FinFET produces extremely large leakage current of about 340 μA, and GAAFETs produces extremely large leakage current of about 15 nA.

Although researches on the NEM switch has been conducted for a long time, there are several reasons of preventing the NEM switch from being substantially applied to the power gating technology as follows.
1) Incompatibility of being applied to power gating system at microsecond-level: Typically researched electromechanical switches are designed to have a large contact area between two electrodes and strong contact force, thereby reducing the on-resistance. Thus, all the electromechanical switches exhibiting low on-resistance are realized at a micro-size. However, due to the large contact area and the wide air gap, the switching time at the micro-second level is not appropriate for the power gating system. Although there are researches that improve the switching time to a nano-second level by scaling a size of the electromechanical switch to the nano-second level, there is a high limit point in that the on-resistance is in a range from kilo-ohms (kΩ) to mega-ohms (MΩ). As described above, it is considered in a field of the electromechanical switch that the low on-resistance and the fast-switching time have a trade-off relationship, and no electromechanical switches have not satisfied both factors so far.
2) High on-resistance due to uniform mechanical structure: The on-resistance of the NEM-PGS is required to be 1Ω or less to avoid the logic delay while the NEM-PGS blocks the leakage current. However, as the NEM-PGS is scaled down to a nano-size, driving force decreases to an extremely weak level of a nano-newton (nN) level. Thus, it is extremely difficult and challenging to achieve the on-resistance of 1Ω or less. Therefore, it is essential to develop innovative mechanical structure capable of maximizing the contact force. Since most current NEM-PGSs have a simple cantilever-type or plate-type structure having one fixed end among both ends, the NEM-PGSs are not suitable for generating high contact force and have on-resistance of several kΩ.
3) Difficulty in CMOS wiring integration: The NEM-PGS is required to be monolithically integrated into a wire of the semiconductor system to minimize the logic delay of the semiconductor system and fundamentally block the leakage current. However, integration of the NEM-PGS into the CMOS wire remains a highly challenging task because of some reasons such as compatibility with CMOS BEOL process/material, low-temperature process that does not affect CMOS circuits, and lack of a nano-fabrication facility.

Thus, the current researches on the NEM-PGS have clear technical limitations. In order to overcome the technical limitations, researches in innovative structures, processes, and wire integration are required.

### SUMMARY

The present invention provides an electrostatically driven electromechanical switch having a fast-switching time and a method for manufacturing the same.

The present invention also provides an electrostatically driven electromechanical switch having low on-resistance and a method for manufacturing the same.

The present invention also provides an electrostatically driven electromechanical switch having extremely low leakage current (<1 fA) and a method for manufacturing the same.

The present invention also provides an electrostatically driven electromechanical switch having a low power characteristic and a method for manufacturing the same.

An embodiment of the present invention provides an electromechanical switch including: a substrate; a first electrode disposed on the substrate; a second electrode spaced apart from the first electrode on the substrate; a third electrode disposed on the first electrode and the second electrode, including a contact part spaced apart from the first electrode to form an air gap, and bringing the contact part into mechanical contact with the first electrode by electrostatic force with the second electrode.

In an embodiment of the present invention, a method for manufacturing an electromechanical switch includes: an electrode formation process of forming a first electrode, a second electrode, and an electrode part of a third electrode to be spaced apart from each other on a substrate; a first deposition process of depositing a first sacrificial layer on the substrate, the first electrode, the second electrode, and the electrode part of the third electrode; a first removal process of removing a portion of the first sacrificial layer deposited on the first electrode and the second electrode to expose a portion of a top surface of each of the first electrode and the second electrode to the outside; a second deposition process of depositing a second sacrificial layer on the exposed portion of each of the first electrode and the second electrode and the first sacrificial layer; a second removal process of removing a portion of the second sacrificial layer deposited on the portion of the top surface of the first electrode to expose a portion of the top surface of the first electrode to the outside; a third deposition process of depositing a third sacrificial layer on the exposed portion of the first electrode and the second sacrificial layer; a third removal process of removing a portion of the third sacrificial layer deposited on an electrode part of the third electrode to expose a portion of a top surface of the third electrode; a third deposition process of depositing the third electrode on the exposed portion of the top surface of the third electrode and the third sacrificial layer; and a fourth removal process of removing the first to third sacrificial layers.

### BRIEF DESCRIPTION OF THE FIGURES

FIG. 1 is a graph explaining dynamic power density and leakage power density according to CMOS scaling.

FIG. 2 is a schematic view illustrating a power gating (PG) technology.

FIG. 3 is a graph that compares current-voltage (I-V) characteristics of next-generation new elements applicable to PG.

FIG. 4 is a view illustrating an example of an inverter operating at 500° C. using a typical NEM element.

FIG. 5 is a view illustrating an example of an ultra-low-power non-volatile memory using the typical NEM element.

FIG. 6 is a perspective view illustrating an electromechanical switch according to an embodiment of the present invention.

FIG. 7 is a cross-sectional view taken along line A-A′ of the electromechanical switch in FIG. 6.

FIG. 8 is a graph illustrating a variation in switching time based on an air gap between a first electrode and a contact part of a third electrode of the electromechanical switch in FIG. 6.

FIG. 9 is a view for explaining an operation of the electromechanical switch in FIGS. 6 and 7.

FIG. 10 is a cross-sectional view illustrating a modified example of the electromechanical switch in FIGS. 6 and 7.

FIGS. 11 to 20 are views for explaining a method for manufacturing the electromechanical switch in FIG. 10.

FIG. 21 is a graph explaining a parameter analysis of the electromechanical switch according to an embodiment of the present invention.

FIG. 22 is a view illustrating a simulation result of the electromechanical switch designed based on a simulation according to an embodiment of the present invention.

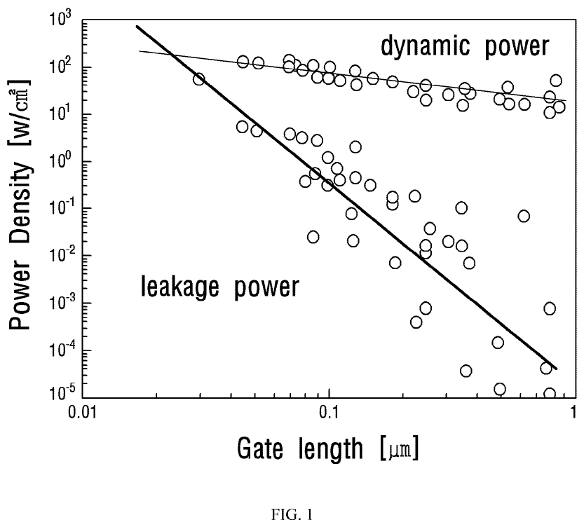

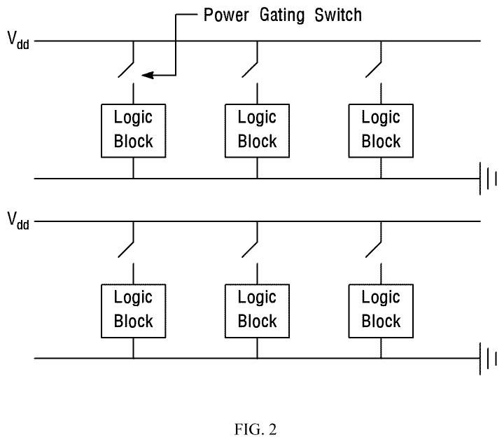

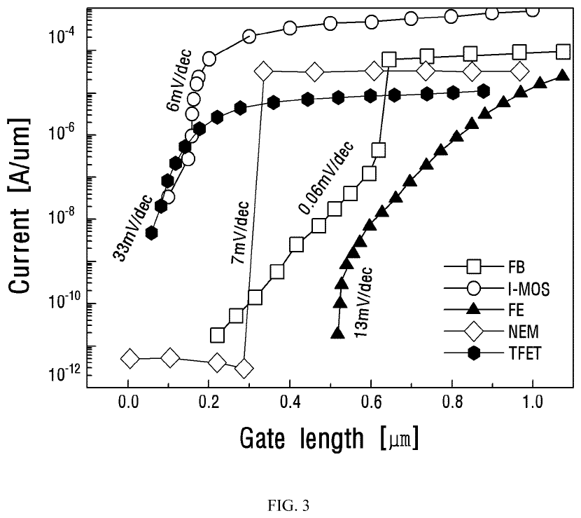

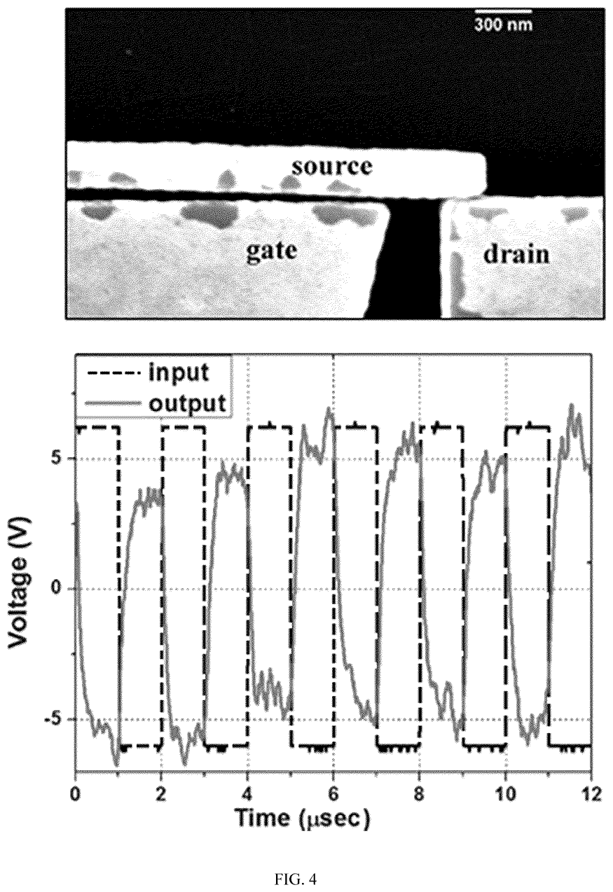

### DETAILED DESCRIPTION

Hereinafter, preferred embodiments of the present invention will be described in detail with reference to the accompanying drawings. It will be understood that the same reference numerals designate the same components throughout the drawings. For reference, detailed descriptions related to well-known functions or configurations will be ruled out in order not to unnecessarily obscure subject matters of the present invention.

Hereinafter, an electromechanical switch and a method for manufacturing the same will be described in detail with reference to the accompanying drawings.

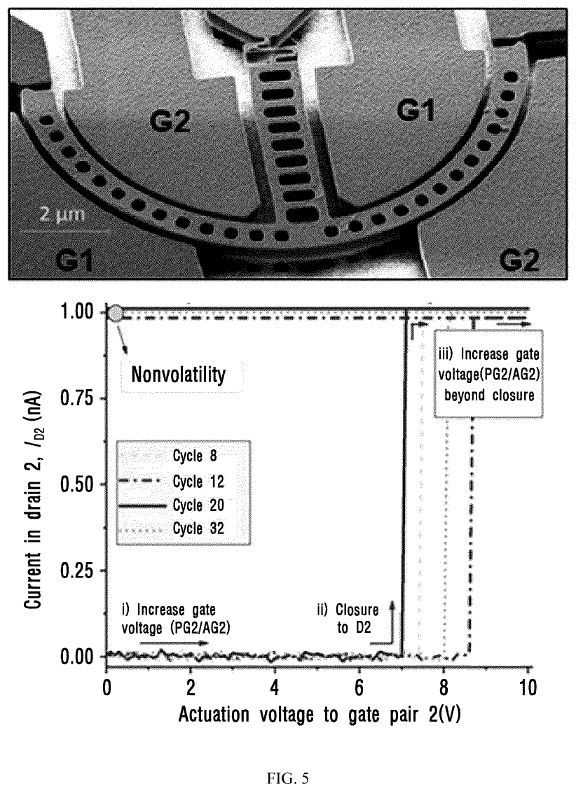

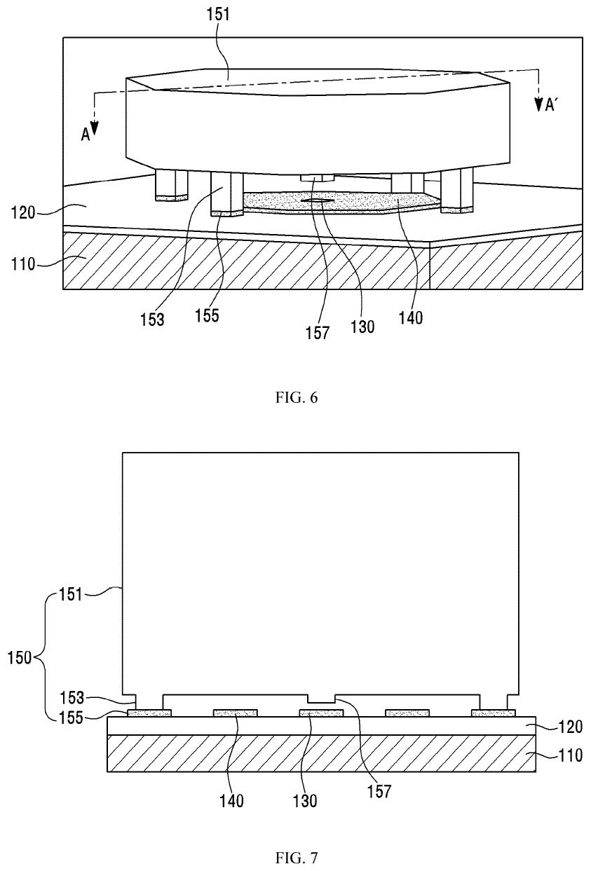

FIG. 6 is a perspective view illustrating an electromechanical switch according to an embodiment of the present invention, and FIG. 7 is a cross-sectional view taken along line A-A′ of the electromechanical switch in FIG. 6.

Referring to FIGS. 6 and 7, the electromechanical switch according to an embodiment of the present invention includes a substrate 110, an insulation layer 120, a first electrode 130, a second electrode 140, and a third electrode 150.

The insulation layer 120 is disposed on the substrate 110. The insulation layer 120 having a predetermined thickness may be disposed on a top surface of the substrate 110.

The insulation layer 120 is disposed between the substrate 110 and the first to third electrodes 130, 140, and 150. The insulation layer 120 blocks electrical connections between the first, second, and third electrodes 130, 140, and 150. Here, the insulation layer 120 may be a component of the substrate 110.

The first to third electrodes 130, 140, and 150 may be disposed on the insulation layer 120.

The first electrode 130 is disposed on a top surface of the insulation layer 120. The first electrode 130 may be referred to as a drain electrode. The first electrode 130 may be disposed on a central portion of the substrate 110.

The second electrode 140 is disposed on the top surface of the insulation layer 120. The second electrode 140 may be referred to as a gate electrode. The second electrode 140 may surround at least a portion or an entirety of the first electrode 130. The second electrode 140 may have a ring shape.

The third electrode 150 may be referred to as a source electrode. Since the third electrode 150 has a predetermined spring constant, at least one portion of the third electrode 150 may undergo displacement by external force. When the external force is removed, the at least one portion may be returned to an original state thereof.

Here, the spring constant may be in a range from 50 kN/m to 300 kN/m. Since mechanical restoration force of the third electrode 150 is insufficient when the spring constant of the third electrode 150 is less than 50 kN/m, the electromechanical switch may be permanently adhered in an on state and may not be returned to an off state. In particular, since a nanoscale air gap is formed between a contact part of the third electrode 150 and the first electrode 130, the spring constant may be equal to or greater than 50 kN/m. On the other hand, when the spring constant of the third electrode 150 is greater than 300 kN/m, there is a limitation in that an operating voltage of the electromechanical switch increases.

The third electrode 150 is disposed on the first electrode 130 and the second electrode 140. The third electrode 150 may undergo displacement due to electrostatic force with the second electrode 140, and at least one portion of the third electrode 150 may be brought into mechanical contact with the first electrode 130. When the electrostatic force is removed, the at least one portion may be released from the mechanical contact with the first electrode 130.

The third electrode 150 may include a body part 151, a support part 153, an electrode part 155, and a contact part 157.

The body part 151, the support part 153, the electrode part 155, and contact part 157 may be made of the same metal material as each other. Here, the body part 151, the support part 153, and contact part 157 may be made of the same first metal, and the electrode part (155) may be made of second metal. The first metal may be nickel, and the second metal may be gold.

The body part 151 is disposed on the insulation layer 120. The body part 151 may have a predetermined volume. The body part 151 may have a top surface, a bottom surface, and at least one side surface. The body part 151 may have one of various shapes such as a cylinder, a cone, a truncated cone, a polygonal cylinder, a polygonal pyramid, or a truncated polygonal pyramid. However, the embodiment of the present invention is not limited to the shape of the body part 151 in the drawings.

The support part 153 is disposed below the body part 151 and supports the body part 151 to be disposed on the first electrode 130 and the second electrode 140. The support part 153 may be disposed between the body part 151 and the electrode part 155. At least two support parts 153 may be disposed on the bottom surface of the body part 151 or the support part 153 may protrude downward from the bottom surface of the body part 151. At least two support parts 153 may be disposed on an edge of the bottom surface of the body part 151.

The support part 153 is disposed on the electrode part 155. The support part 153 may be disposed to contact a top surface of the electrode part 155. The number of support parts 153 may correspond to that of the electrode part 155. The support part 153 may one-to-one correspond to the electrode part 155.

The electrode part 155 may be disposed on the same layer as the first electrode 130 and the second electrode 140. The electrode part 155 may be disposed around the second electrode 140.

The contact part 157 may be disposed on or protrude downward from the bottom surface of the body part 151. The contact part 157 may be disposed on an area facing the first electrode 130 in the bottom surface of the body part 151. The contact part 157 is spaced a predetermined distance from the first electrode 130.

A nanoscale air gap may be formed between the contact part 157 and the first electrode 130. Here, the air gap may be in a range from 10 nm (nanometers) to 30 nm. The air gap may reduce a leakage current of the electromechanical switch to be less than 1 fA in an off state of the electromechanical switch. As illustrated in FIG. 8, when the air gap is less than 10 nm, it is difficult to manufacture the electromechanical switch, and reliability on an operation of the electromechanical switch is degraded. Also, when the air gap is greater than 30 nm, a switching time of the electromechanical switch may increase to be equal to or greater than 50 ns (nanoseconds), which causes switching to be slow.

The contact part 157 may have a vertical length (thickness) less than that of the support part 153.

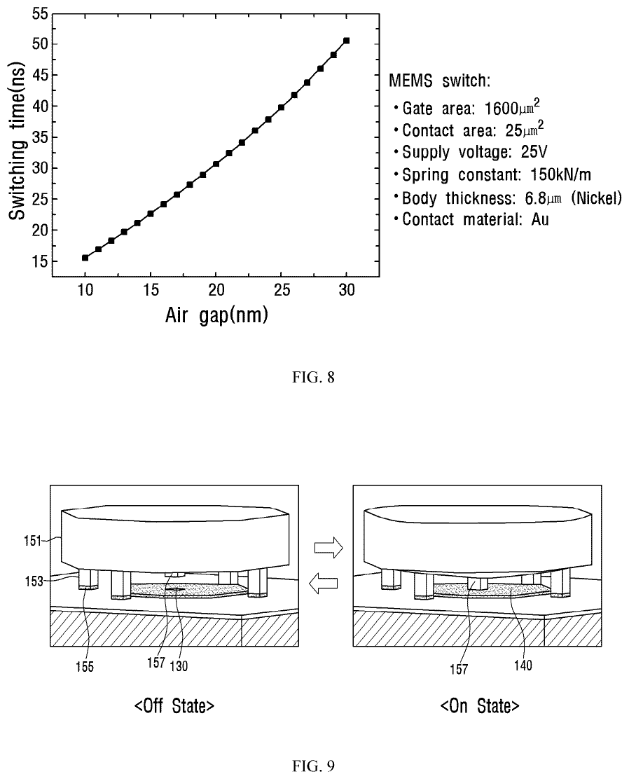

FIG. 9 is a view for explaining the operation of the electromechanical switch in FIGS. 6 and 7.

Referring to FIGS. 6 and 7, the electromechanical switch according to an embodiment of the present invention may operate in two distinct states that are an off state and an on state. In FIG. 9, a left drawing represents the off state, and a right drawing represents the on state.

In the off state, the contact part 157 of the third electrode 150 is physically spaced apart from the first electrode 130. Since the contact part 157 of the third electrode 150 is spaced apart from the first electrode 130, current flowing between the third electrode 150 and the first electrode 130 is close to zero. In particular, the air gap between the contact part 157 of the third electrode 150 and the first electrode 130 fundamentally blocks a current flow caused by tunneling. Thus, the electromechanical switch according to an embodiment of the present invention exhibits a characteristic of an extremely low leakage current less than 1 fA in the off state. This leakage current characteristic may allow the electromechanical switch according to an embodiment of the present invention to be used as a power gating switch, and when used as the power gating switch, standby power consumption may be significantly reduced.

In the on state, the contact part 157 of the third electrode 150 is brought into physical and electrical contact with the first electrode 130. A method of bringing the contact part 157 of the third electrode 150 into contact with the first electrode 130 applies a predetermined voltage to the second electrode 140 that functions as a gate electrode to generate electrostatic force caused by a voltage difference between the second electrode 140 and the body part 151 of the third electrode 150. When the voltage applied to the second electrode 140 increases so that the electrostatic force between the second electrode 140 and the body part 151 of the third electrode 150 exceeds mechanical restoration force of the body part 151 of the third electrode 150, a pull-in phenomenon, in which the bottom surface of the body part 151 of the third electrode 150 is bent downward by the electrostatic force so that the contact part 157 contacts the first electrode 130, occurs. Here, the mechanical contact between the contact part 157 and the first electrode 130 forms an electrically conductive state between the third electrode 150 and the first electrode 130.

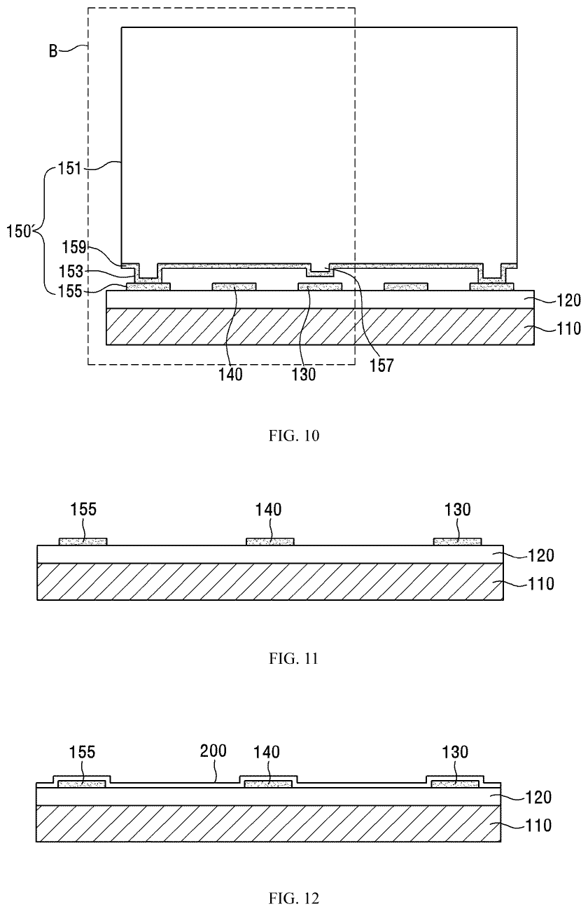

FIG. 10 is a cross-sectional view illustrating a modified example of the electromechanical switch in FIGS. 6 to 7.

Referring to FIG. 10, the electromechanical switch according to a modified example includes a third electrode 150′ that is distinguished from the third electrode 150 in FIGS. 6 to 7.

The third electrode 150′ further includes an electrode layer 159 that covers a bottom surface of a body part 151, a support part 153, and a contact part 157.

The electrode layer 159 may have a uniform thickness.

The electrode layer 159 includes a portion disposed between the support part 153 and the electrode part 155, and the portion has a top surface contacting a bottom surface of the support part 153 and a bottom surface contacting a top surface of the electrode part 155.

The body part 151, the support part 153, and the contact part 157 may be integrated with each other and made of first metal, and the electrode layer 159 may be made of second metal different from the first metal. Here, the second metal may have electrical conductivity greater than that of the first metal. For example, the second metal may be gold or silver, and the first metal may be nickel. On the other hand, the electrode part 155 may be also made of the second metal.

FIGS. 11 to 20 are views for explaining a method for manufacturing the electromechanical switch in FIG. 10. Here, FIGS. 11 to 20 shows a method for manufacturing portion B of FIG. 10.

Referring to FIG. 11, an insulation layer 120 is formed on the substrate 110, and a first electrode 130, a second electrode 140, and an electrode part 155 of a third electrode are formed on a top surface of the insulation layer 120.

The insulation layer 120 may be made of aluminum nitride (AlN). Each of the first electrode 130, the second electrode 140, and the electrode part 155 of the third electrode may be made of gold (Au) and have a deposition thickness of 150 nm.

Referring to FIG. 12, a first sacrificial layer 200 is deposited with a predetermined thickness on the insulation layer 120, the first electrode 130, the second electrode 140, and the electrode part 155 of the third electrode. The first sacrificial layer 200 may be made of hafnium oxide (HfO₂), have a deposition thickness of 40 nm to 60 nm, and be deposited in an atomic layer deposition (ALD) method.

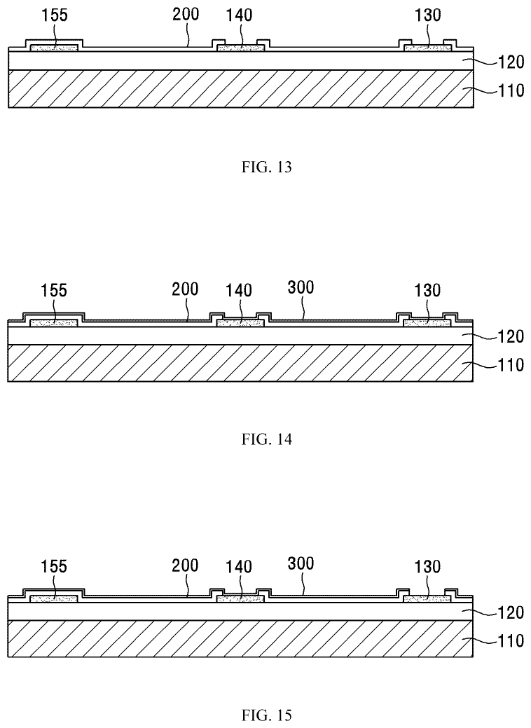

Referring to FIG. 13, a portion of a top surface of each of the first electrode 130 and the second electrode 140 is exposed to the outside by removing a portion of the first sacrificial layer 200 deposited on the first electrode 130 and the second electrode 140.

Referring to FIG. 14, a second sacrificial layer 300 is formed on the exposed portion of the top surface of each of the first electrode 130 and the second electrode 140 and on the first sacrificial layer 200. The second sacrificial layer (300) may be made of be hafnium oxide (HfO₂), have a deposition thickness of 10 nm to 30 nm, and be deposited in the ALD method.

Referring to FIG. 15, a portion of the top surface of the first electrode 130 may be exposed by removing a portion of the second sacrificial layer 300 formed on the first electrode 130.

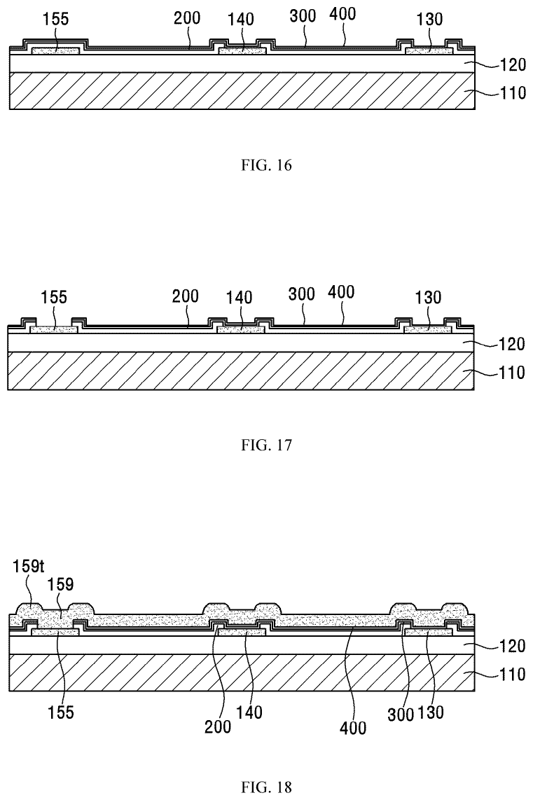

Referring to FIG. 16, a third sacrificial layer 400 is formed on the exposed portion of the top surface of the first electrode 130 and on the second sacrificial layer 300. The second sacrificial layer (400) may be made of be hafnium oxide (HfO₂), have a deposition thickness of 10 nm to 30 nm, and be deposited in the ALD method.

Referring to FIG. 17, a portion of a top surface of the electrode part 155 of the third electrode is exposed to the outside by removing a portion of the first to third sacrificial layers 200, 300, and 400 disposed on the electrode part 155 of the third electrode.

Referring to FIG. 18, an electrode layer 159 is formed on the exposed portion of the top surface of the electrode part 155 and on the third sacrificial layer 400. The electrode layer 159 may be made of gold (Au) or titanium (Ti) and have a deposition thickness of 250 nm. The electrode layer 159 is brought into physical contact with the electrode part 155. On the other hand, when the body part 151 of the third electrode is directly deposited instead of depositing the electrode layer 159, the electromechanical switch in FIG. 7 may be manufactured.

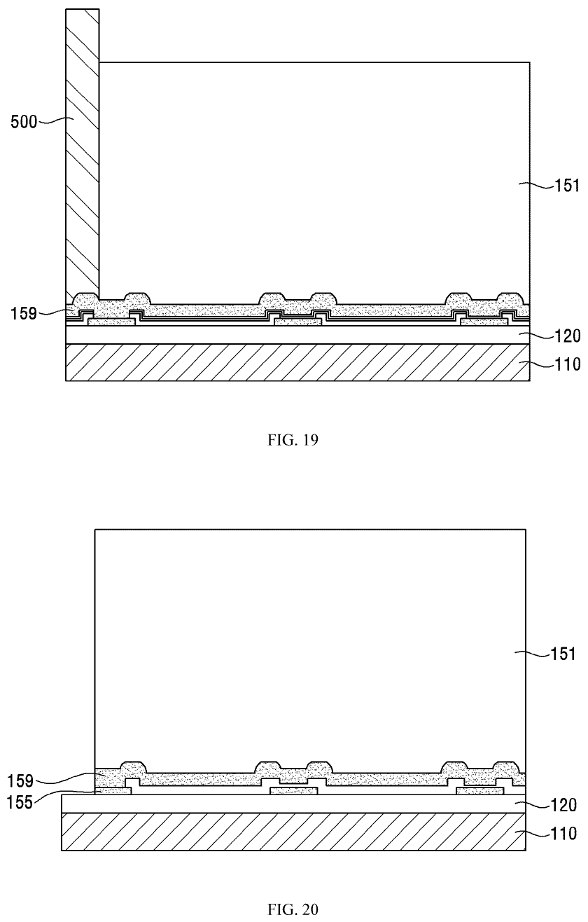

Referring to FIG. 19, each of a photoresist (PR) mold 500 and a body part 151 of the third electrode is formed with a predetermined thickness on the electrode layer 159. The PR mold 500 may have a deposition thickness of 15 μm, and the body part 151 may have a deposition thickness of 7 μm.

Referring to FIG. 20, portions of the electrode layer 159 and the electrode part 155 formed below the PR mold 500 is removed together with the PR mold 500. Thereafter, the first to third sacrificial layers 200, 300, and 400 are removed in a wet etching method.

Also, the sacrificial layers are formed between the two electrodes by using the reliable ALD method and the nano-air gap may be formed between the first electrode 130 and the contact part 157 of the third electrode through a release process of etching the sacrificial layers.

The inventor(s) calculates quantitative effects of each dimension parameter of the above-described electromechanical switch in FIG. 6 or 10 according to an embodiment of the present invention on on-resistance and switching time.
1) On-Resistance: A following <Mathematical equation 1> is a calculation formula for the on-resistance of the electromechanical switch.

$${R}_{on} = 0.001 \times ρ \sqrt{\frac{H}{{F}_{c} {A}_{c}}} \qquad [ Mathematical equation 1 ]$$

In <Mathematical Equation 1>: Rₒₙ represents on-resistance, ρ represents resistivity, H represents hardness, F_{c} represents contact force, and A_{c} represents a contact area.
2) Switching Time: A transient analysis of the electromechanical switch may be expressed by a M-K equation of motion including a mass (m) and a spring (k). The equation of motion, which represents a mechanical behavior of the switch based on dimension parameters and applied force of the electromechanical switch, is expressed as <Mathematical equation 2>:

$$m \frac{{d}^{2} x}{{dt}^{2}} + kx = {F}_{e} = \frac{{ϵ}_{0} {AV}_{s}^{2}}{2 {( g - x )}^{2}} \qquad [ Mathematical equation 2 ]$$

In the <Mathematical equation 2>, m represents Mass, k represents stiffness (or spring constant), ε represents permittivity, A represents area, Vₛ represents supply voltage, and g represents air gap.

Here, the switching time Tₒₙ may be calculated by integrating a displacement x of the electromechanical switch with respect to time t based on the <Mathematical equation 2>. The inventor(s) uses Python code capable of calculating a solution of an integral equation by inputting a boundary condition of the M-K equation of motion and the dimension parameters of the electromechanical switch thereinto.
3) Parameter analysis: The inventor(s) develop a Python code capable of inducing on-resistance and switching time through dimension parameters of the electromechanical switch and then quantitatively calculate an effect of each dimension parameter on the on-resistance and the switching time. When each of the dimension parameters of the electromechanical switch increases by 1%, a variation amount of each of the on-resistance and the switching time is calculated to determine the effect of each dimension parameter.

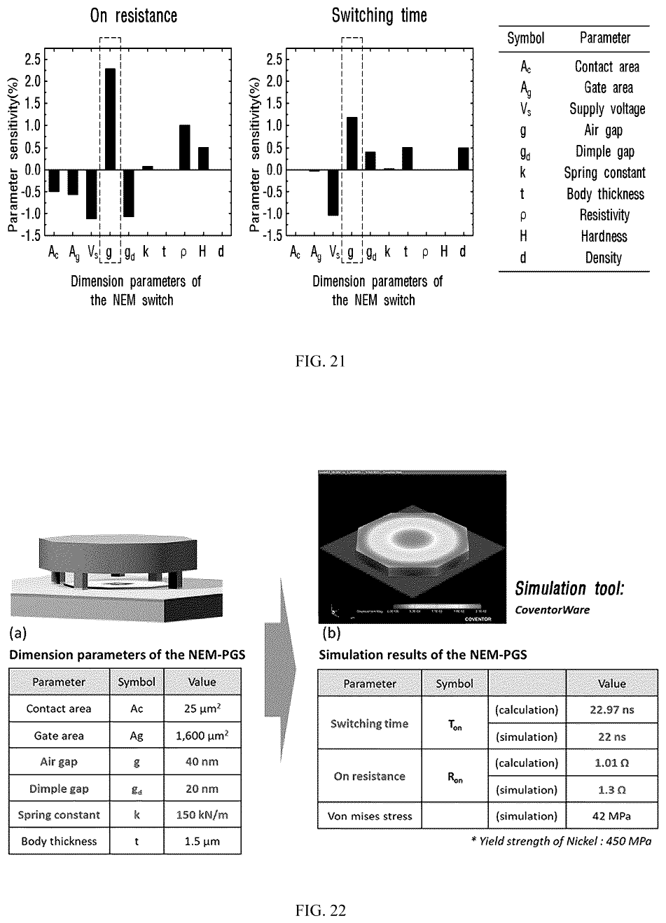

FIG. 21 is a graph illustrating results obtained by calculating a dimension parameter analysis of the electromechanical switch. In this graph, a y-axis represents a percentage change of the on-resistance and the switching time when a parameter of an x-axis increases by 1%. It is understood through the parameter analysis that the air gap of the electromechanical switch significantly influences both the on-resistance and the switching time. Also, it is confirmed that a NEM-PGS for power gating requires a design that extremely reduces the air gap.

The inventor(s) concludes that the air gap is required to be extremely reduced to achieve the low on-resistance and the fast-switching time based on the dimension parameter analysis. However, the extremely small air gap may cause permanent adhesion of the electromechanical switch, thereby generating a failure of an element.

The electromechanical switch generates a displacement in a portion of the third electrode by electrostatic force between the second electrode that is a gate and the third electrode that is a source. When the electrostatic force is greater than mechanical restoration force of the displaced portion of the third electrode, the third electrode is brought into contact with the first electrode that is a drain, and thus, the electromechanical switch is switched to the on state. When the electrostatic force between the third electrode (source) and the second electrode (gate) is removed by removing a voltage applied to the second electrode (gate) in the on state, the electromechanical switch is returned to the off state that is an original state thereof by the mechanical restoration force of the displaced portion of the third electrode (source). Here, the electromechanical restoration force of the third electrode may be expressed as a product of a displacement x and a spring constant k of the third electrode as in following <Mathematical equation 3>.

Fᵣ=k×x [Mathematical equation 3]

Since the electromechanical switch invented by the inventor(s) is designed to extremely reduce the air gap, the air gap corresponding to the displacement x is extremely small, and the mechanical restoration force is also extremely small. Thus, since the restoration force is not great enough to overcome adhesive force between the third electrode (source) and the first electrode (drain), the electromechanical switch may not be restored to the off state, and thus, a failure in which the third electrode (source) is permanently adhered to the first electrode (drain) may occur.

The inventor(s) propose a design that significantly increases the mechanical spring constant of the electromechanical switch to cancel reduction in mechanical restoration force caused by the small air gap. The inventor(s) estimate the mechanical restoration force required to overcome the adhesive force and design the electromechanical switch having the mechanical spring constant k suitable for the mechanical restoration force through a following design process. The inventor(s) invent and use an adhesive force estimation model for estimating the adhesive force generated in a contact portion between the third electrode (source) and the first electrode (drain) when the electromechanical switch is in the on state.

The adhesive force estimation model calculates the adhesive force under a given contact situation by comprehensively calculating sequential deformations of nano-asperities generated when two surfaces contact each other, and, at this time, metallic bonding force and van der waals force therebetween. The air gap and the spring constant k of the electromechanical switch are set to have restoration force greater than the adhesive force calculated through the adhesive force estimation model. Finally, as illustrated in FIG. 22, the electromechanical switch having the set spring constant and air gap is designed, and the design is verified through a simulation. The term “dimple gap” in FIG. 22 represents a gap between the contact part 157 and the first electrode 130 in FIG. 6, and the term “air gap” represents a gap between the bottom surface of the body part 151 and the second electrode 140 in FIG. 6.

The electromechanical switch according to the embodiment of the present invention has an advantage of the fast-switching time.

Also, the electromechanical switch has another advantage of the low on-resistance.

Also, the electromechanical switch has another advantage of the extremely low leakage current.

Also, the electromechanical switch may be applied to various semiconductor applied fields that require low power, and an innovation at the level of the architecture integrated with the CMOS integrated circuit may be expected.

Also, as the element suitable for the power gating system that turns the power on and off at the logic block unit to minimize the leakage power consumption, the electromechanical switch may be used as the solution to the limitation of the explosive increase in power consumption for data processing in technologies of the fourth industrial revolution such as artificial intelligence, the internet of things, and autonomous driving.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electromechanical switch comprising:
a substrate;
a first electrode disposed on the substrate;
a second electrode spaced apart from the first electrode on the substrate;
a third electrode disposed on the first electrode and the second electrode, comprising a contact part spaced apart from the first electrode to form an air gap, and configured such that the contact part mechanically contacts the first electrode by electrostatic force with the second electrode.

2. The electromechanical switch of claim 1,
wherein the air gap is in a range from 10 nm to 30 nm.

3. The electromechanical switch of claim 1,
wherein the spring constant of the third electrode is in a range from 50 kN/m to 300 kN/m.

4. The electromechanical switch of claim 1,
wherein the electromechanical switch has an on state in which the contact part of the third electrode is brought into contact with the first electrode and an off state in which the contact part of the third electrode forms the air gap with the first electrode, and
wherein a switching time between the on state and the off state is less than 50 ns.

5. The electromechanical switch of claim 1,
further comprising an insulation layer disposed between the first to third electrodes and the substrate.

6. The electromechanical switch of claim 1,
wherein the electrostatic force is greater than a mechanical restoration force of the third electrode.

7. The electromechanical switch of claim 1,
wherein the third electrode comprises:
a body part spaced upward from the first electrode and the second electrode;
an electrode part disposed at one side of the second electrode on the substrate; and
a support part disposed between the body part and the electrode part to support the body part so that the body part is spaced upward from the first electrode and the second electrode,
wherein the contact part protrudes in a direction from a bottom surface of the body part toward the first electrode.

8. The electromechanical switch of claim 7,
wherein the second electrode surrounds the first electrode on the substrate, and
wherein at least two support parts of the third electrode are disposed around the second electrode on the substrate.

9. The electromechanical switch of claim 7,
wherein a distance between the bottom surface of the body part and the second electrode is greater than the air gap between the contact part and the first electrode.

10. The electromechanical switch of claim 7,
wherein the third electrode further comprises an electrode layer disposed to cover the bottom surface of the body part, the support part, and the contact part.

11. The electromechanical switch of claim 10,
wherein each of the body part, the support part, and the contact part is made of first metal, and
wherein the electrode layer is made of second metal having electrical conductivity greater than that of the first metal.

12. The electromechanical switch of claim 11,
wherein the first metal is nickel, and
wherein the second metal is gold or silver.

13. A method for manufacturing an electromechanical switch, the method comprising:
an electrode formation process of forming a first electrode, a second electrode, and an electrode part of a third electrode to be spaced apart from each other on a substrate;
a first deposition process of depositing a first sacrificial layer on the substrate, the first electrode, the second electrode, and the electrode part of the third electrode;
a first removal process of removing a portion of the first sacrificial layer deposited on the first electrode and the second electrode to expose a portion of a top surface of each of the first electrode and the second electrode to the outside;
a second deposition process of depositing a second sacrificial layer on the exposed portion of each of the first electrode and the second electrode and the first sacrificial layer;
a second removal process of removing a portion of the second sacrificial layer deposited on the portion of the top surface of the first electrode to expose a portion of the top surface of the first electrode to the outside;
a third deposition process of depositing a third sacrificial layer on the exposed portion of the first electrode and the second sacrificial layer;
a third removal process of removing a portion of the third sacrificial layer deposited on an electrode part of the third electrode to expose a portion of a top surface of the third electrode;
a third deposition process of depositing the third electrode on the exposed portion of the top surface of the third electrode and the third sacrificial layer; and
a fourth removal process of removing the first to third sacrificial layers.

14. The method of claim 13,
wherein the third deposition process comprises:
forming an electrode layer of the third electrode on the exposed portion of the top surface of the third electrode and the third sacrificial layer; and
forming a body part of the third electrode on the electrode layer.

15. The method of claim 14,
wherein the body part is made of first metal, and
wherein the electrode layer is made of second metal having electrical conductivity greater than that of the first metal.

16. The method of claim 13,
wherein each of the first to third sacrificial layers is made of hafnium oxide (HfO₂),
wherein each of the first to third sacrificial layers is deposited in an atomic layer deposition (ALD) method, and
wherein the first sacrificial layer has a deposition thickness greater than that of each of the second and third sacrificial layers.

17. The method of claim 15,
wherein the third sacrificial layer has a thickness of 10 nm to 30 nm.

18. The method of claim 13,
wherein the third electrode is manufactured through a low-temperature plating process in the third deposition process.
